(19) United States
(12) Patent Application Publication
(10) Pub. No.: US 2026/0304085 A1
(43) Pub. Date: Oct. 1, 2026

(54) METHODS FOR IDENTIFYING THE OPERATOR OF TRANSMITTED FRAMES AND FOR CHECKING OPERATOR MEMBERSHIP, COMMUNICATION DEVICE AND COMMUNICATION GATEWAY

(71) Applicant: ORANGE, Issy-les-Moulineaux (FR)

(72) Inventors: Halim Bendiabdallah, Chatillon Cedex (FR); Isabelle Soumoy, Chatillon Cedex (FR)

(21) Appl. No.: 19/690,526

(22) Filed: May 28, 2026

Related U.S. Application Data
(62) Division of application No. 16/623,980, filed on Jun. 7, 2018.

(30) Foreign Application Priority Data
Jun. 19, 2017 (FR) FR1755570

(51) Int. Cl. H04W 4/70; H04L 9/32; H04L 9/40; H04W 12/041; H04W 12/06; H04W 12/106; H04W 12/108

(52) U.S. Cl. CPC H04W 4/70; H04L 9/3247; H04L 63/0442; H04L 63/062; H04L 63/0884; H04L 63/12; H04W 12/041; H04W 12/06; H04W 12/106; H04W 12/108

(57) ABSTRACT

In a method of verifying membership in an operator infrastructure of a destination server of frames received by a gateway of the operator infrastructure, the gateway receives frames transmitted over a first network by a communication device, and performs a first decryption of the received frames using a gateway private key stored in the gateway, termed a gateway decryption. A successful decryption of a frame by the gateway indicates that the decrypted frame belongs to the operator infrastructure.

### CROSS-REFERENCE TO RELATED APPLICATIONS

This Application is division of U.S. application Ser. No. 16/623,980, filed Jun. 18, 2019, which is a Section 371 National Stage Application of International Application No. PCT/FR2018/000166, filed Jun. 7, 2018, and published as WO 2018/234641 A2 on Dec. 27, 2018, not in English, which claims priority to French Patent Application No. FR1755570, filed Jun. 19, 2017, the entire contents of which are incorporated herein by reference.

### FIELD OF THE DISCLOSURE

The invention relates to a method of operator identification of frames to be sent, a method of verification of operator membership, a communication device and a communication gateway. In particular, the invention relates to an identification and a verification of operator membership of frames in the context of transmission on low-consumption wireless communication networks such as LoRa (registered trademark), SigFox (registered trademark), etc.

### BACKGROUND OF THE DISCLOSURE

The field of connected objects is booming. Multiple connected objects are invading our everyday existence: our houses (home-automation: thermostat, opening, etc., monitoring: weather station, detector, etc.), our person (watch, bathroom scales, etc.), our environment, etc. The operators of telecommunication networks offer a communication network dedicated to these connected objects: a low-consumption wireless communication network, on account of the limited capabilities of connected objects. Among the existing low-consumption wireless communication networks offered are the SigFox (registered trademark), LoRaWan (registered trademark) networks, etc. via which the information is received from the connected objects and is thereafter conveyed through the Internet network.

Accordingly, antennas capable of demodulating the signal of the wireless network, in particular the LoRa radio signal, into a signal compliant with a protocol of the Internet network, such as the TCP/IP protocol, are installed. These antennas are coupled to a gateway which decodes the frames received via the low-consumption wireless communication network and dispatches them to a network server according to an Internet protocol such as TCP or UDP. The network server is capable of determining, or indeed of verifying, from among the frames received those originating from connected objects associated with the operator infrastructure of the network server. To determine and optionally validate the received frames, the network server relies on keys stored in its database, if the keys do not correspond, the message contained in the frame is ignored. Thus, the network server will not process the frames sent by connected objects which are not associated with it. This makes it possible to reduce the processing load of the network server.

Nonetheless, the systematic transmission to a network server of all the frames received by a gateway associated with this network server of connected object(s) present in the zone of coverage of the gateway gives rise to an overloading of the network traffic and of the invoking of the network server.

### SUMMARY

One of the aims of the present invention is to remedy drawbacks of the prior art.

A subject of the invention is a method of operator identification of frames to be sent by a communication device of an operator infrastructure via a first communication network. The method of operator identification comprises a first encryption, termed gateway encryption, by the communication device of the operator infrastructure, of a frame destined for a network server with a gateway public key associated with the communication device in the operator infrastructure, the gateway public key being paired with a gateway private key stored in at least one gateway of the operator infrastructure.

Thus, the load of the second communication network between the gateway and the network server will be able to be reduced, as will the processing load of the network server.

In particular, the method of operator identification comprises a generating of a digest of the frame destined for the network server as a function of an integrity key, the digest and the integrity key being added to the frame destined for the network server prior to gateway encryption.

Thus, not only will the load be limited to the frames belonging to the operator infrastructure of the network server for which they are destined but also only to the valid frames, that is to say that have not undergone any modification on account of transmission.

A subject of the invention is also a method of transmission of frames by a communication device of an operator infrastructure via a first communication network. The method of transmission of frames comprises a first encryption, termed gateway encryption, by the communication device of the operator infrastructure, of a frame destined for a network server with a gateway public key associated with the communication device in the operator infrastructure, the gateway public key being paired with a gateway private key stored in at least one gateway of the operator infrastructure.

In particular, the method of transmission comprises, prior to the first encryption, a second encryption, termed server encryption, of a frame destined for a network server with a server private key, the server private key being paired with a server public key stored in a network server of the operator infrastructure.

Thus, the data of the frame remain very secure since they are accessible only when the frame has been received by the network server. Indeed, the gateways being weaker in terms of security than the servers, moving the location of server keys to the gateways would increase the risks in terms of security of the frames. Furthermore, this avoids the overloading of the gateways which are linked with a distributing of the server keys in the gateways so that the gateway filters the frames as a function of their membership in the place of the network server on account of the large number of server keys.

A subject of the invention is also a method of verification of membership in an operator infrastructure of a destination server of frames received by a gateway of the operator infrastructure. The method of verification comprises a first decryption of the frames received by means of a gateway private key stored in the gateway, termed gateway decryption, a success of the gateway decryption of a frame indicating that the decrypted frame belongs to the operator infrastructure.

In particular, the method of verification comprises a comparison of a digest contained in the decrypted frame with a digest of a useful part of decrypted frame generated by means of an integrity key contained in the decrypted frame, a result of equality of the comparison indicating the success of the gateway decryption of the frame.

A further subject of the invention is a method of filtering frames received by a gateway of a network infrastructure. The method of filtering comprises a transmission to a network server of the network infrastructure of at least one frame received from a communication device via a first decrypted communication network by means of a gateway private key stored in the gateway if the gateway decryption of the frame is successful.

In particular, the method of filtering comprises a blocking of at least one decrypted received frame if the gateway decryption of the frame is a failure.

Thus, the gateway is not overloaded by a processing to determine the destination of the frame received.

A subject of the invention is, furthermore, a method of generating asymmetric gateway keys which is implemented upon the attachment of a communication device to an operator infrastructure. The method of generating gateway keys comprises a providing of the gateway key pair generated by transmitting the gateway public key of the pair generated to the communication device and the gateway private key of the pair generated to at least one gateway of the operator infrastructure.

Advantageously, according to an implementation of the invention, the various steps of the method according to the invention are implemented by a computer program or software, this software comprising software instructions intended to be executed by a data processor of a device forming part of an operator infrastructure, respectively a communication device, such as a connected object, a gateway, a network server and being designed to control the execution of the various steps of this method.

The invention therefore also envisages a program comprising program code instructions for the execution of the steps of the method of operator identification, and/or of the method of transmission or of the method of verification of membership, and/or of the method of filtering, or of the method of generating keys as claimed in the preceding claim when said program is executed by a processor.

This program can use any programming language and be in the form of source code, object code or code intermediate between source code and object code such as in a partially compiled form or in any other desirable form.

A subject of the invention is a communication device of an operator infrastructure able to transmit frames via a first communication network. The communication device comprises a first encrypter, termed gateway encrypter, the gateway encrypter being able to encrypt at least one frame destined for a server of the operator infrastructure with a gateway public key associated with the communication device in the operator infrastructure, the gateway public key being paired with a gateway private key stored in at least one gateway of the operator infrastructure.

In particular, the first communication network is a low-consumption wireless communication network.

A subject of the invention is also a gateway of an operator infrastructure able to transmit frames received from a communication device via a first communication network to a network server of the operator infrastructure via a second communication network. The gateway comprises a frame filter able to transmit a received frame decrypted by means of a gateway private key stored in the gateway if the gateway decryption of the frame is successful.

A subject of the invention is also a network server of an operator infrastructure able to receive frames which are sent by a communication device via a first communication network and are relayed by a gateway via a second communication network. The network server comprises an analyzer of received frames, the analyzer being fed with all the frames originating from the gateway, the gateway having transmitted to the network server a frame received from a communication device if the gateway decryption, by means of a gateway private key stored in the gateway, of the frame received from the communication device is successful.

In particular, the network server comprises a generator of pairs of gateway keys providing a gateway public key to a communication device and a gateway private key to at least one gateway of the operator infrastructure upon the attachment of the communication device to an operator infrastructure comprising the network server

### BRIEF DESCRIPTION OF THE DRAWINGS

The characteristics and advantages of the invention will become more clearly apparent on reading the description, given by way of example, and the figures pertaining thereto which represent:

FIGS. 1a and 1b, simplified diagrams of communication architecture comprising a gateway between a first communication network and a second communication network, respectively, in which the validation of the frames is performed in the network server according to the prior art, and in which the gateway filters the frames as a function of their membership in the operator infrastructure of the destination network server according to the invention;

FIGS. 2a and 2b, simplified diagrams relating to the distributing of the gateway keys according to the invention, respectively a simplified diagram of an implementation of the distributing of the gateway keys according to the invention, and a simplified diagram of the exchanges and methods implemented in the communication architecture during the distributing of the gateway keys;

FIG. 3, a simplified diagram of the exchanges and methods implemented in the communication architecture during the dispatching of frames from a communication device to a network server, according to the invention;

FIG. 4, a simplified diagram of the exchanges and methods implemented in the communication architecture during the filtering of the frames by the gateway, according to the invention;

FIGS. 5a and 5b, a simplified diagram of the methods implemented respectively by the communication device and by the gateway according to the invention;

FIG. 6 a simplified diagram of a communication architecture according to the invention.

### DETAILED DESCRIPTION OF ILLUSTRATIVE EMBODIMENTS

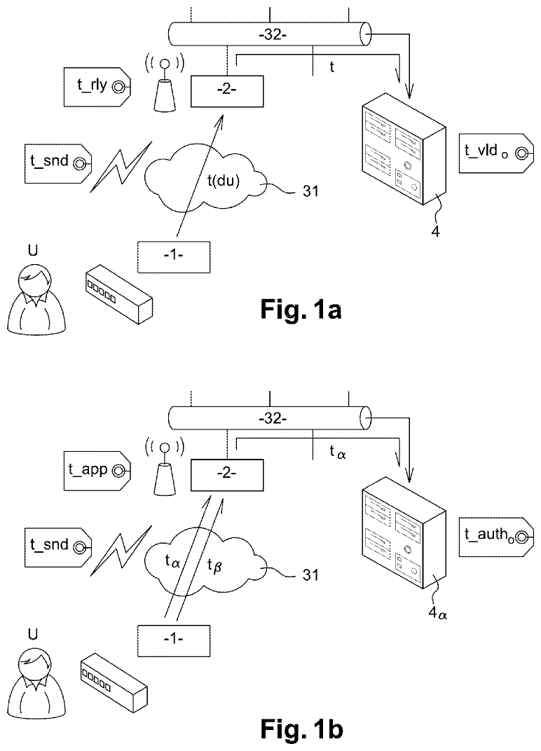

FIGS. 1a and 1b illustrate simplified diagrams of communication architecture comprising a gateway between a first communication network and a second communication network.

FIG. 1a illustrates a communication architecture in which the validation of the frames is performed in the network server according to the prior art. The communication architecture comprises a first communication network 31, in particular a wireless communication network, and a second communication network 32, in particular an Internet network.

The communication architecture of FIG. 1a comprises a communication device 1, in particular a connected object such as a communication device using the LoRa technology, also named LoRa Device in English. The communication device 1 is connected to a network server 4 in particular by way of the first communication network 31: a wireless communication network. In the case of a connected object 1, the first communication network 31 is a low-consumption wireless communication network.

The communication architecture then comprises, for example, a gateway 2 receiving the frames sent t_snd by one or more communication devices 1 via the first communication network 31 (the frames t(du) comprising useful data du), and transmitting t_rly the frames t(du) via a second network 32, in particular an Internet network, in particular, in packet form to a network server 4. The gateway 2 is in particular able to receive so-called LoRa frames, that is to say frames sent by a communication device 1 using the LoRa technology, the gateway 2 is then termed a LoRa gateway. The Internet network 32 is in particular a network implementing the TCP/IP protocol.

When the technology used by the connected object 1 is LoRa, the network server 4, NS, validates the received frame, that is to say that it verifies whether the frame received is sent by a connected object 1 associated with the network server 4. The network server 4, the gateway 2 and the associated connected object then constitutes an operator infrastructure. If the frame received by the network server 4 belongs to its operator infrastructure, then the network server 4 undertakes the processing of the frame received: analysis and/or storage . . . Otherwise, the frame received is rejected by the network server 4, that is to say it acts as if it had not received it since it is of no interest to it.

FIG. 1b illustrates a communication architecture in which the gateway filters the frames as a function of their membership in the operator infrastructure of the destination network server according to the invention. The communication architecture comprises a first communication network 31, in particular a wireless communication network, and a second communication network 32, in particular an Internet network.

The communication architecture of FIG. 1a comprises a communication device 1, in particular a connected object such as a communication device using the LoRa technology, also named LoRa Device in English. The communication device 1 is connected to a network server 4 in particular by way of the first communication network 31: a wireless communication network. In the case of a connected object 1, the first communication network 31 is a low-consumption wireless communication network.

The communication architecture then comprises, for example, a gateway 2 receiving the frames sent t_snd by one or more communication devices 1 via the first communication network 31 (the frames tα, tβ comprising useful data du). The gateway 2 according to the invention verifies the membership t_app of the frame tα, tβ to the operator infrastructure of the destination network server 4α. Next, the gateway 2 transmits t_rly the frames tα, identified as belonging to the destination network server 4α via a second network 32, in particular an Internet network, for example, in packet form. Otherwise, the frame received tβ is rejected by the gateway 2, that is to say it acts as if it had not received it since it is of no interest to the network server 4α.

The gateway 2 is in particular able to receive so-called LoRa frames, that is to say frames sent by a communication device 1 using the LoRa technology, the gateway 2 is then termed a LoRa gateway. The Internet network 32 is in particular a network implementing the TCP/IP protocol.

When the technology used by the connected object 1 is LoRa, the network server 4α, NS, authenticates the frame received t_authₒ. Next, the network server 4 undertakes the processing of the frame received: analysis and/or storage, etc.

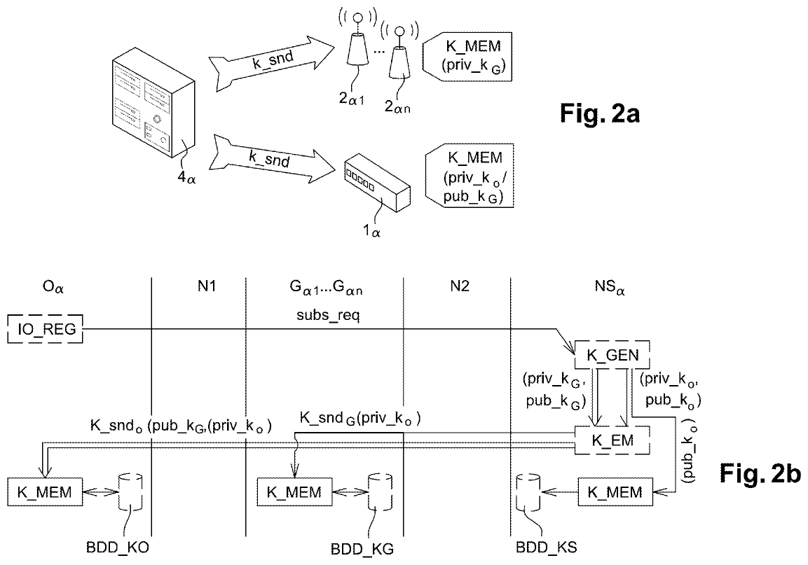

FIGS. 2a and 2b illustrate simplified diagrams relating to the distributing of the gateway keys according to the invention.

FIG. 2a illustrates a simplified diagram of an implementation of the distributing of the gateway keys according to the invention. The network server 4α of an operator infrastructure distributes the keys that it has generated k_snd.

The network server 4α distributes a gateway asymmetric key pair consisting of a gateway private key priv_k_{G} and of a gateway public key pub_k_{G}. The gateway public key pub_k_{G} is dispatched to a communication device 1α for which it has been generated and which stores it K_MEM. The gateway private key priv_k_{G} is dispatched to at least one, or indeed to all the, gateway(s) 2α₁ . . . 2αᵥ of the operator infrastructure of the network server 4α which stores it K_MEM.

Thus, the communication device 1α will be able will encrypt the frames to be sent with the gateway public key pub_k_{G} allowing the gateway 2 receiving the frames to verify their membership in the operator infrastructure of the destination network server 4 by means of the gateway private key priv_k_{G} so as to transmit to the destination network server 4 only the frames belonging to its operator infrastructure.

In particular, the network server 4α distributes, furthermore, to an associated communication device a private network key priv_ko allowing the communication device 1α to sign the frames that it transmits and to the network server 4α to authenticate the communication device 1α which sent the frames that it receives.

FIG. 2b illustrates a simplified diagram of the exchanges and methods implemented in the communication architecture during the distributing of the gateway keys.

In particular, during the distributing of the gateway keys, the network server NSα implements a method of generating asymmetric gateway keys K_GEN which is implemented upon the attachment of a communication device Oα to an operator infrastructure α.

The method of generating gateway keys K_GEN comprises a providing K_PROV of the gateway key pair generated (priv_k_{G}, pub_k_{G}) by transmitting K_EM the gateway public key pub_k_{G} of the pair generated to the communication device Oα and the gateway private key of the pair generated priv_k_{G} to at least one gateway Gα₁ . . . Gαₙ of the operator infrastructure α.

Optionally, the generation of keys K_GEN provides, furthermore, a network key pair specific to a communication device and consisting of a network private key priv_k_{O} and of a network public key pub_k_{O}. The network private key priv_k_{O} is transmitted to the communication device Oα. The network public key pub_k_{O} is, in particular, recorded K_MEM by the network server NSα, for example, in a database BDD_KS comprising keys generated and/or used by the network server NSα.

Thus, the network server NSα sends K_EM a signal of transmission of keys comprising the gateway private key k_snd_{G}(priv_k_{G}) destined for at least one gateway Gα₁ . . . Gαₙ, and a signal of transmission of keys comprising the gateway public key and, if relevant, the network private key k_snd_{O}(pub_ k_{G}, priv_k_{O}) destined for the communication device Oα.

In particular, the generation of gateway keys K_GEN is triggered by a reception, by the network server NSα, of a request for association subs_req of a communication device with the operator infrastructure of the network server NSα. In particular, a communication device Oα implements a registering in an operator infrastructure IO_REG by dispatching the request for association subs_req.

In particular, a gateway Gα₁ . . . Gαₙ receiving K_REC a gateway private key priv_k_{G} records it K_MEM, for example, in a database BDD_KG comprising keys received and/or used by the gateway Gα₁ . . . Gαₙ.

In particular, a communication device Oα receiving K_REC at least one key (at least one being a gateway public key pub_k_{G} and, the if appropriate, a network private key priv_k_{O)} records them K_MEM, for example, in a database BDD_KO comprising keys received and/or used by the communication device Oα.

A particular embodiment of the method of generating keys is a program comprising program code instructions for the execution of the steps of the method of generating keys when said program is executed by a processor.

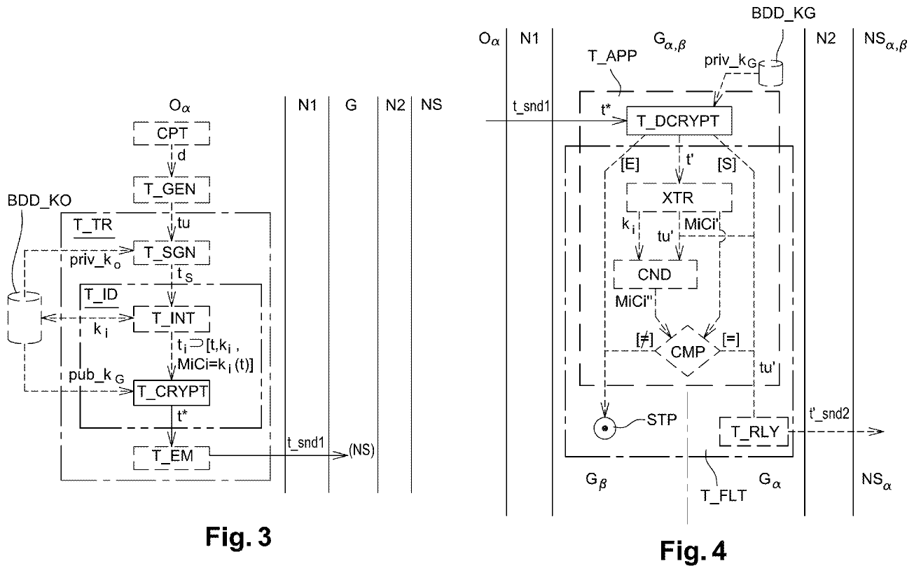

FIG. 3 illustrates a simplified diagram of the exchanges and methods implemented in the communication architecture during the dispatching of frames from a communication device to a network server, according to the invention.

FIG. 3 shows, in particular, a method of operator identification of frames to be sent T_ID by a communication device Oα of an operator infrastructure via a first communication network N1. The method of operator identification T_ID comprises a first encryption T_CRYPT, termed gateway encryption, by the communication device Oα of the operator infrastructure, of a frame ts destined for a network server NS with a gateway public key pub_K_{G} associated with the communication device Oα in the operator infrastructure, the gateway public key pub_K_{G} being paired with a gateway private key priv_K_{G} stored in at least one gateway G of the operator infrastructure.

In particular, the method of identification T_ID comprises a reading of the gateway public key pub_K_{G} stored in the communication device Oα implementing it, for example in a database of keys BDD_K_{O} of the communication device Oα. The communication device Oα having recorded therein the gateway public key pub_K_{G} during a step of a method implemented by the communication device prior to the transmission of frames to a network server NS such as illustrated by FIG. 2b, in particular the reception of the gateway public key pub_K_{G} subsequent to its dispatching by a method of generating keys implemented by a network server NSα and/or a method of registering the communication device Oα with the network server NSα.

In particular, the method of operator identification T_ID comprises a generating T_INT of a digest MICI−MICI=ki(ts)—of the frame ts destined for the network server NS as a function of an integrity key ki. The digest MICI and the integrity key ki are added to the frame ts destined for the network server NS prior to the gateway encryption T_CRYPT: ti=[ki, ts, MICI]. In particular, the method of identification T_ID comprises a reading of the integrity key ki stored in the communication device Oα implementing it, for example in a database of keys BDD_K_{O} of the communication device Oα.

In particular, prior to the first encryption T_CRYPT, a second encryption T_SGN, termed server encryption, of a frame tu destined for a network server NS with a server private key priv_kO, the server private key priv_k_{O} being paired with a server public key pub_k_{O} stored in a network server NS of the operator infrastructure α.

In a particular embodiment, the communication device Oα implements a method of transmission of frames T_TR via a first communication network N1. The method of transmission of frames T_TR comprises a first encryption T_CRYPT, termed gateway encryption, by the communication device Oα of the operator infrastructure, of a frame ts destined for a network server NS with a gateway public key pub_k_{G} associated with the communication device Oα in the operator infrastructure.

In particular, the method of transmission T_TR comprises a reading of the gateway public key pub_K_{G} stored in the communication device Oα implementing it, for example in a database of keys BDD_K_{O} of the communication device Oα. The communication device Oα having recorded therein the gateway public key pub_K_{G} during a step of a method implemented by the communication device prior to the transmission of frames to a network server NS such as illustrated by FIG. 2b, in particular the reception of the gateway public key pub_K_{G} subsequent to its dispatching by a method of generating keys implemented by a network server NSα and/or a method of registering the communication device Oα with the network server NSα.

In particular, the method of transmission T_TR comprises a sending T_EM via the first communication network N1 of the enciphered frame t* destined for a network server NS in the form of a useful signal t_snd1.

In particular, the method of transmission T_TR comprises, prior to the first encryption T_CRYPT, a second encryption T_SGN, termed server encryption, of a frame tu destined for the network server NS with a server private key priv_k_{O}, the server private key priv_k_{O} being paired with a server public key pub_k_{O} stored in a network server NS of the operator infrastructure α.

In particular, the method of transmission T_TR comprises a reading of the network private key priv_K_{O} stored in the communication device Oα implementing it, for example in a database of keys BDD_K_{O} of the communication device Oα. The communication device Oα having recorded therein the network private key priv_K_{O} during a step of a method implemented by the communication device prior to the transmission of frames to a network server NS such as illustrated by FIG. 2b, in particular the reception of the network private key priv_K_{O} subsequent to its dispatching by a method of generating keys implemented by a network server NSα and/or a method of registering the communication device Oα with the network server NSα.

In particular, the method of transmission T_TR comprises a generating T_INT of a digest MICI−MICI=ki(ts)—of the frame ts destined for the network server NS as a function of an integrity key ki. The digest MICI and the integrity key ki are added to the frame ts destined for the network server NS prior to the gateway encryption T_CRYPT: ti=[ki, ts, MICI]. In particular, the method of identification T_ID comprises a reading of the integrity key ki stored in the communication device Oα implementing it, for example in a database of keys BDD_K_{O} of the communication device Oα.

In particular, the method of transmission T_TR comprises the method of operator identification T_ID.

In particular, the communication device Oα receives (not illustrated) or generates T_GEN frames tu on the basis of useful data d. These useful data d are, in particular, data captured subsequent to a capture CPT implemented, for example, by the communication device Oα.

For example, the communication device Oα is a connected object of sensor type: temperature sensor, camera, presence detector, rain detector, reader of barcodes or QR codes, RFID chip reader... then the data d captured by the communication device Oα are directly distributed T_GEN into frames to be sent tu.

Optionally, some connected objects form part of a home-automation network with a home-automation platform receiving the data d captured by at least some of the connected objects of the home-automation network, the home-automation platform then constitutes a communication device Oα according to the invention and distributes T_GEN the captured data received dr into frames to be sent tu. In one embodiment, not illustrated, the home-automation platform Oα performs analyses and/or processings of the captured data received and distributes T_GEN the captured data received dr and/or, the analysis results ra and/or processing results rt into frames to be sent tu.

In particular, the communication device Oα sends T_EM via the first communication network N1 the frame enciphered t* by means of the first encryption T_CRYPT destined for a network server NS in the form of a useful signal t_snd1. The destination server can be a network server NS belonging or otherwise to the same operator infrastructure as the communication device Oα. If the network server NS belongs to the same operator infrastructure, it will analyze and/or process the useful frame contained in the enciphered frame dispatched t*, otherwise it will ignore it.

The first encryption T_CRYPT allows the frame dispatched by the communication device Oα to be ignored by the network server NS when they do not belong to the same operator infrastructure α in that the gateway G placed between the two does not transmit the frame to the destination network server NS in this case.

A particular embodiment of the method of operator identification and/or of the method of transmission is a program comprising program code instructions for the execution of the steps of the method of operator identification, and/or of the method of transmission when said program is executed by a processor.

FIG. 4 illustrates a simplified diagram of the exchanges and methods implemented in the communication architecture during the filtering of the frames by the gateway, according to the invention.

In particular, the gateway receives T_REC (step of receiving frames, which is not illustrated) the frames sent t_snd1 by the communication device Oα via the first communication network N1, in particular such as illustrated by FIG. 3.

The gateway Gα, Gβ implements, in particular, a method of verification of membership T_APP in an operator infrastructure of a destination server NSα, NSβ of frames received t_snd by a gateway of the operator infrastructure Gα, Gβ. The method of verification T_APP comprises a first decryption T_DCRYPT of the frames received t* by means of a gateway private key priv_k_{G} stored in the gateway Gα, Gβ, termed gateway decryption. A success [S] of the gateway decryption of a frame indicating that the decrypted frame t′ belongs to the operator infrastructure α, β of the destination server of the frame NSα, NSβ.

In particular, the method of verification T_APP comprises a comparison CMP of a digest MICI′ contained in the decrypted frame t′ with a digest MICI″ of a useful part tu′ of decrypted frame generated by means of an integrity key k'i contained in the decrypted frame. A result of equality of the comparison [=] indicating the success [S] of the gateway decryption of the frame.

This result [S], [=] of membership of the decrypted frame tu′ in the operator infrastructure allows the gateway Gα, Gβ to transmit t_snd2 via the second communication network N2 to the destination server NSα, NSβ the decrypted frame tu′ belonging to the operator infrastructure α, β. In particular, subsequent to the verification of membership T_APP, the gateway implements a transmission T_RLY to the destination server NSα, NSβ of the decrypted frame tu′ belonging to the operator infrastructure α, β of the destination server NSα, NSβ.

In particular, the method of filtering T_FLT comprises, subsequent to the first decryption T_DCRYPT, an extraction XTR of the decrypted frame t′ a useful part tu′ of the decrypted frame t′. In particular, the extraction XTR is triggered if the gateway decryption T_DCRYPT of the frame t′ is a success [S], [=].

In particular, the method of verification T_APP comprises an extraction of the decrypted frame t′ an integrity key ki′, a useful part tu′ of the decrypted frame t′ and a digest MICI′ and then a generation CND of a digest of verification MICI″ of the useful part tu′ extracted as a function of the integrity key extracted ki′. The digest of verification MICI″ and the digest extracted MICI′ are provided to the comparison CMP.

In a particular embodiment, the gateway Gα, Gβ implements a method of filtering T_FLT of frames received by a gateway of a network infrastructure Gα, Gβ. The method of filtering T_FLT comprising a transmission T_RLY to a network server of the network infrastructure NSα, NSβ of at least one frame tu′ received from a communication device Oα via a first decrypted communication network N1 by means of a gateway private key priv_k_{G} stored in the gateway Gα, Gβ if the gateway decryption T_DCRYPT of the frame is successful [S].

In particular, the method of filtering T_FLT comprises a blocking STP of at least one decrypted received frame tu′ if the gateway decryption T_DCRYPT of the frame is a failure [E].

In a particular embodiment, subsequent to the reception T_REC (not illustrated) of frames originating from a communication device Oα, a verification of membership T_APP of the frames received in the operator infrastructure of the destination network server is implemented and, as a function of the network of this verification of membership T_APP, a filtering of the frames T_FLT makes it possible to transmit T_RLY to the destination network server the frames belonging to the same operator infrastructure as the destination network server, and optionally to block the other frames STP. Thus, the implementation of a filtering of the frames destined for the network server as a function of the operator infrastructure to which they belong at the level of the gateway makes it possible to reduce the load of the second communication network N2 as well as the processing load of the network server NS.

In particular, the method of filtering T_FLT comprises, previously, on transmission T_RLY, an extraction XTR of the decrypted frame t′ a useful part tu′ of the decrypted frame t′. In particular, the extraction XTR is triggered if the gateway decryption T_DCRYPT of the frame t′ is a success [S], [=].

In particular, the method of filtering T_FLT comprises a comparison CMP of a digest MICI′ contained in the decrypted frame t′ with a digest MICI″ of a useful part tu′ of decrypted frame generated by means of an integrity key k'i contained in the decrypted frame. A result of equality of the comparison [=] indicating the success [S] of the gateway decryption of the frame.

In particular, the method of filtering T_FLT comprises an extraction XTR of the decrypted frame t′ an integrity key ki′, a useful part tu′ of the decrypted frame t′ and a digest MICI′ and a generation CND of a digest of verification MICI′ of the useful part tu′ extracted as a function of the integrity key extracted ki′. The digest of verification MICI″ and the digest extracted MICI′ are provided to the comparison CMP.

In particular, the method of filtering T_FLT comprises a first decryption T_DCRYPT of the frames received t* by means of a gateway private key priv_k_{G} stored in the gateway Gα, Gβ, termed gateway decryption. A success [S] of the gateway decryption of a frame indicating that the decrypted frame t′ belongs to the operator infrastructure α, β of the destination server of the frame NSα, NSβ.

In particular, the method of filtering T_FLT comprises the method of verification of membership T_APP.

In the case where a communication device Oα of an operator infrastructure or first operator infrastructure α sends t_snd 1 a frame t* destined for a network server NSα of the same operator infrastructure, that is to say of the first operator infrastructure α, the gateway Gα receiving the frame t* via the first communication network N1 has at its disposal the gateway private key priv_k_{G} paired with the gateway public key pub_k_{G} used by the communication device Oα during the first encryption T_CRYPT providing the encrypted frame t* sent. Consequently, the first decryption T_DCRYPT, also named gateway decryption, implemented by the gateway Gα uses the gateway private key priv_k_{G} paired with the gateway public key pub_k_{G} used by the communication device Oα during the first encryption T_CRYPT providing the encrypted frame t* sent. The gateway decryption will then be successful [S] in this case indicating that the frame sent t* belongs to the operator infrastructure α of the destination network server NSα. The gateway Gα will then forward T_RLY via the second communication network N2 the decrypted frame t′ (at least the useful part of this decrypted frame tu′) to the destination network server NSα, for example by means of a transmission signal t′_snd2.

In the case where a communication device Oα of an operator infrastructure or first operator infrastructure α sends t_snd 1 a frame t* destined for a network server NSβ of another operator infrastructure, that is to say of a second operator infrastructure β distinct from the first operator infrastructure, the gateway Gβ receiving the frame t* via the first communication network N1 does not have at its disposal the gateway private key priv_k_{G} paired with the gateway public key pub_k_{G} used by the communication device Oα during the first encryption T_CRYPT providing the encrypted frame t* sent.

Either, the gateway Gβ does not have at its disposal for this communication device Oα any gateway private key and, consequently, the first decryption T_DCRYPT, also named gateway decryption, implemented by the gateway Gα cannot be executed.

Or, the gateway Gβ has at its disposal for this communication device Oα a gateway private key associated with the second operator infrastructure priv_k_{G}β and, consequently, the first decryption T_DCRYPT, also named gateway decryption, implemented by the gateway Gα uses a gateway private key priv_k_{G}β which is not the gateway private key priv_k_{G} paired with the gateway public key pub_k_{G} used by the communication device Oα during the first encryption T_CRYPT providing the encrypted frame t* sent. Consequently, the gateway decryption T_DCRYPT provides a result which does not constitute a decryption of the frame received t*.

The gateway decryption will then be a failure [E] in this case indicating that the frame sent t* does not belong to the operator infrastructure β of the destination network server NSβ. The gateway Gβ will optionally block STP the result t′ of the gateway decryption, that is to say that the frame received from the communication device Oα will not be transmitted to the destination network server NSβ.

A particular embodiment of the method of verification of membership, and/or of the method of filtering is a program comprising program code instructions for the execution of the steps of the method of verification of membership, and/or of the method of filtering when said program is executed by a processor.

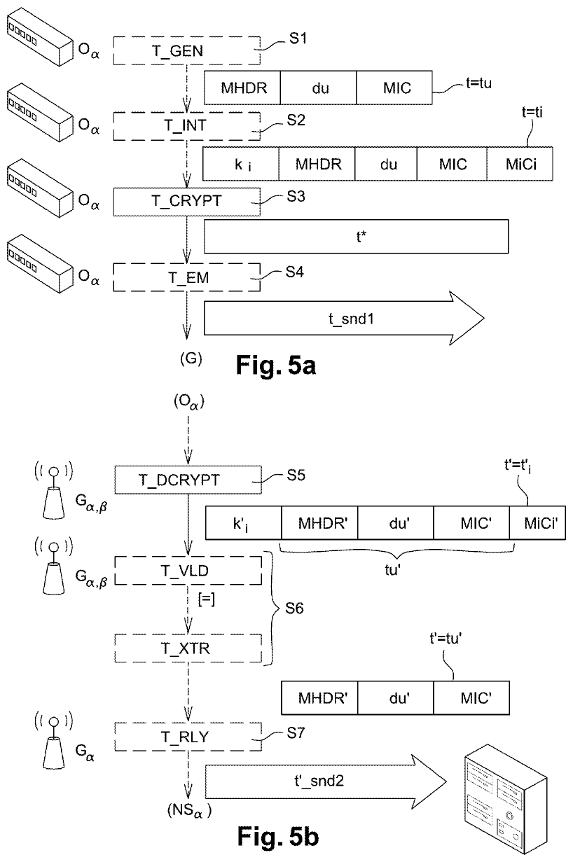

FIGS. 5a and 5b illustrate simplified diagrams of the methods implemented respectively by the communication device and by the gateway according to the invention.

FIG. 5a shows the steps implemented by a communication device Oα according to the invention.

In particular, during a generating step constituting for example a first step S1, the communication device Oα generates T_GEN component frames t of a useful part tu. This useful frame tu is composed of useful data du provided by the communication device Oα, also named MACPayload in the LoRa standard, and, in particular, of a header MHDR, also named message header, and of a an integrity code MIC of the message consisting of the useful data du.

Optionally, during an integrity step constituting for example a second step S2, the communication device Oα generates T_INT a digest MICI−MICI=ki(ts)—of the frame t destined for the network server NS as a function of an integrity key ki. The digest MICI and the integrity key ki are added to the frame t destined for the network server NS prior to the gateway encryption T_CRYPT: t=ti=[ki, ts, MICI].

During a step of first encryption constituting for example a third step S3, the communication device Oα performs a first encryption T_CRYPT, termed gateway encryption, of a frame t destined for a network server NS with a gateway public key pub_K_{G} associated with the communication device Oα in the operator infrastructure. The gateway public key pub_K_{G} is paired with a gateway private key priv_K_{G} stored in at least one gateway G of the operator infrastructure.

In particular, during a sending step constituting for example a fourth step S4, the communication device Oα sends T_EM via the first communication network N1 to a gateway G the encrypted frame t*, also termed enciphered frame, destined for a network server NS in the form of a useful signal t_snd1.

FIG. 5b shows the steps implemented by a gateway Gα, Gβ subsequent to at least one step illustrated by FIG. 5a.

During a step of first decryption constituting for example a fifth step S5, the gateway Gα, Gβ having received, from a communication device Oα, a useful signal t_snd1 comprising an encrypted frame t* performs a first decryption T_DCRYPT of the frames received t* by means of a gateway private key priv_k_{G} stored in the gateway Gα, Gβ, termed gateway decryption. A success [S] of the gateway decryption of a frame indicating that the decrypted frame t′ belongs to the operator infrastructure α, β of the destination server of the frame NSα, NSβ.

Optionally, during a step of verifying the decryption constituting for example a sixth step S6, the gateway Gα, Gβ validates the decrypted frame in particular by means of an integrity key ki′ included in the decrypted frame t'i.

For example, the validation of the frame is performed by means of a comparison CMP of a digest MICI′ contained in the decrypted frame t′ with a digest MICI″ of a useful part tu′ of decrypted frame generated by means of an integrity key k'i contained in the decrypted frame. A result of equality of the comparison [=] indicating the success [S] of the gateway decryption of the frame.

Optionally, during decryption verification step S6, the gateway Gα, Gβ extracts T_XTR the useful part tu′ of the decrypted frame t′. Either this extraction T_XTR is performed after the validation of the frame T_VLD thus providing the useful frame tu′ to be forwarded to the network server only if decryption is successful as shown by FIG. 5b.

Or this extraction T_XTR is performed before the validation of the frame T_VLD making it possible to provide an integrity key ki′, a useful part tu′ of the decrypted frame t′ and a digest MICI′ to the validation. Indeed, the decrypted frame t′=t'i comprises, if decryption is successful:
a decrypted integrity key ki′ corresponding to the integrity key ki used by the communication device and added to the frame during the integrity step S2,
the decrypted digest MICI′ corresponding to the digest MICI generated by the communication device and added to the frame during the integrity step S2, and
the decrypted useful frame tu′ comprising the decrypted header MHDR, the decrypted useful data du′ and the integrity code of the decrypted message MIC′.

Then, the validation of the frame T_VLD will comprise, optionally, a generation CND of a digest of verification MICI″ of the useful part tu′ extracted as a function of the integrity key extracted ki′. The digest of verification MICI″ and the digest extracted MICI′ are provided to the comparison CMP.

If relevant, during a transmission step constituting for example a seventh step S7, this result [S], [=] of membership of the decrypted frame tu′ in the operator infrastructure allows the gateway Gα to transmit t_snd2 via the second communication network N2 to the destination server NSα the decrypted frame tu′ belonging to the operator infrastructure α. In particular, subsequent to the verification of membership T_APP, the gateway implements a transmission T_RLY to the destination server NSα of the decrypted frame tu′ belonging to the operator infrastructure α of the destination server NSα.

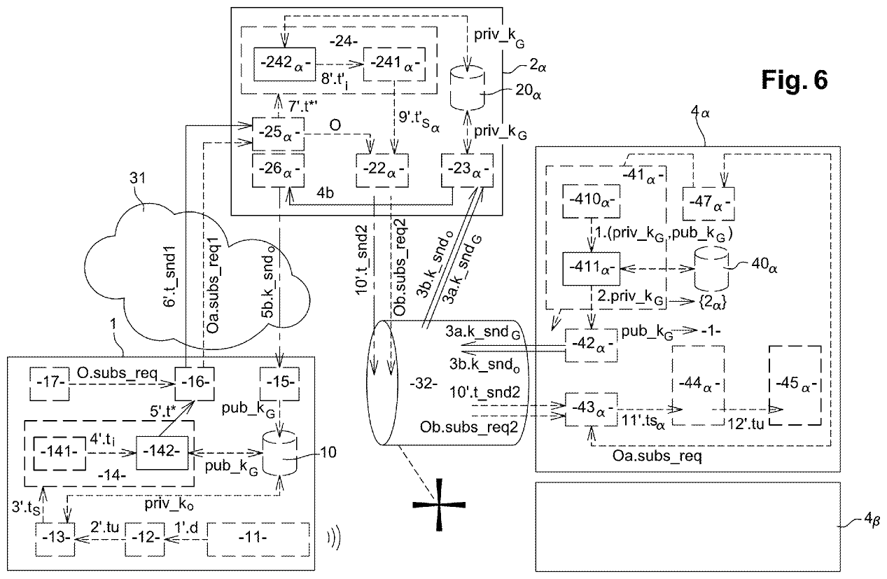

FIG. 6 illustrates a simplified diagram of a communication architecture according to the invention. The communication architecture is composed of a first communication network 31 (local network) and of a second communication network (remote network) linking up communication devices 1 with one or more network servers 4α, 4β optionally belonging to various operator infrastructures α, β. A communication device can be belong to one or more distinct operator infrastructure.

A network server 4α, 4β of an operator infrastructure is able to receive frames which are sent by a communication device 1 via a first communication network 31 and are relayed by a gateway 2α via a second communication network 32. As illustrated for the network server 4α of FIG. 6, the network server 4α, 4β comprises an analyzer 45α of received frames. The analyzer 45α is fed with all the frames originating from the gateway 2α. The gateway 2α allows the transmission to the network server 4α, 4β of a frame received from a communication device if the gateway decryption, by means of a gateway private key stored in the gateway, of the frame received from the communication device is successful.

In particular, the network server 4α comprises a generator 410α of pairs of gateway keys providing 1.(priv_k_{G}, pub_k_{G}) a gateway public key pub_k_{G} to a communication device 1 and a gateway private key priv_k_{G} to at least one gateway 2α of the operator infrastructure α upon the attachment of the communication device 1 to an operator infrastructure α comprising the network server 4α.

In particular, the generator of keys 410α furthermore generates a network key pair (priv_k_{O}, pub_k_{O}) associated with the communication device 1 requesting attachment. The network server 4α stores the network public key pub_k_{O}, in particular in a database 40α of the network server 4α

In particular, the network server 4α comprises a provider of keys 41α pairs of gateway keys (priv_k_{G}, pub_k_{G}) providing 2.priv_k_{G}→{2α}, pub_k_{G}→1 a gateway public key pub_k_{G} to a communication device 1 and a gateway private key priv_k_{G} to at least one gateway 2α. The provider of keys 41α comprising for example the generator of keys 410α. In particular, the provider of keys 41α furthermore comprises a signaling generator 411α formatting the pair of keys to be provided, for example the pair of keys generated by the generator of keys 410α. The signaling signal thus produced makes it possible to distribute the keys of the pair of keys generated: for example, a gateway public key pub_k_{G} to a communication device 1 and a gateway private key priv_k_{G} to at least one gateway 2 of the operator infrastructure α, and/or a network public key pub_k_{O} to the network server 4α and a network private key priv_k_{O} to a communication device 1, etc.

The network server 4α comprises in particular a subscriber 47α receiving a request for attachment 0. subs_req of a communication device 1 to the infrastructure α comprising the network server 4a. Optionally, the subscriber 47α commands either the generator 410 α to produce, or the provider of keys 41α to provide a gateway key pair (priv_k_{G}, pub_k_{G}) associated with the communication device 1 requesting attachment.

In particular, the network server 4α comprises a sender 42α and a receiver 42α on the second communication network 32. Thus, the sender 42α transmits the keys via the second communication network 32 to the gateway(s) 2α: 3a.k_snd_{G}, and to the communication device 1: 3b.k_snd_{O}. The signal destined for the communication device 3b.k_sn_{O} comprises the gateway public key pub_k_{G} and, if relevant, the network private key priv_k_{O}. The gateway receives the two signals 3a.k_sn_{G}G and 3b. k_sn_{O}O, in particular by means of a second receiver 23α, and forwards that destined for the communication device 1 via the first communication network 31, in particular by means of a first sender 26α.

In particular, the gateway 2α stores the gateway private key received priv_k_{G}, in particular in a database 20α of the gateway. And, the communication device 1 stores the key(s) received: the gateway public key pub_kG and, if relevant, the network private key priv_k_{O}, in particular in a database 10 of the communication device 1.

The communication device 1 comprises, in particular, a sender 16 and a receiver 16 via a first communication network 31.

The communication device 1 comprises in particular a recorder 17 in an operator infrastructure α able to request 0.subs_req a network server 4α of the operator infrastructure α for attachment of the communication device 1 to this operator infrastructure α. In particular, the request for attachment 0.subs_req is sent 0a. subs_req1 by the sender 16 via the first network 31. The network server 4α being connected to a second communication network 32, a gateway 2α forwards the request for attachment 0b.subs_req2 to the network server 4α via the second communication network 32, in particular by means of a first receiver 25α receiving the request via the first communication network 31 and of a second sender 22α dispatching it via the second communication network. Thus, the receiver 43α of the network server receives the request for attachment and, for example, commands 0.subs_req the subscriber 47α accordingly.

The communication device 1 of an operator infrastructure, that is to say said device being attached to an operator infrastructure: the operator infrastructure α in the example of FIG. 6 is able to transmit frames via a first communication network 31, in particular by virtue of its sender 16 and its receiver 15. The communication device 1 comprises a first encrypter 142, termed gateway encrypter. The gateway encrypter 142 is able to encrypt at least one frame 3′. ts destined for a server of the operator infrastructure with a gateway public key pub_k_{G} associated with the communication device 1 in the operator infrastructure. The gateway public key is paired with a gateway private key stored in at least one gateway 2α of the operator infrastructure α.

In particular, the first communication network 31 is a low-consumption wireless communication network.

In particular, the communication device 1 comprises at least one sensor 11 providing useful data 1′.d to be transmitted to a network server.

In particular, the communication device 1 comprises a generator of frames 12 placing the useful data d to be transmitted into the form of frames 2′.tu. Optionally, the communication device 1 comprises a second encrypter 13 signing the frames by means of a network private key priv_K_{O}. The frames 2′.t, 3′.ts are provided to the first encrypter 142 either directly or indirectly. In the case where they are provided indirectly, they are firstly provided to a digest generator 141 calculating an integrity digest by means of an integrity key ki and providing to the first encrypter 142 a frame 4′.ti comprising in addition to the frame provided 2′.t, 3′.ts, the integrity key ki used and the integrity digest generated MICI.

Optionally, an operator infrastructure identifier 14 comprises the digest generator 141 and the first encrypter 142.

The encrypted frame 5′.t* is provided by the first encrypter 142 so as to be transmitted to a network server 4α, 4β via the first communication network 31 in particular by means of the sender 16.

The gateway 2α of an operator infrastructure is able to transmit frames received from a communication device 1 via a first communication network 31 to a network server 4α, 4β of the operator infrastructure via a second communication network 32. The gateway 2α comprises a frame filter 24α able to transmit a received frame decrypted by means of a gateway private key priv_k_{G} stored in the gateway 2α if the gateway decryption of the frame is successful.

In particular, the gateway 2α receives, by means of a first receiver 25α a frame sent 6′.t_snd1 by a communication device 1 via the first communication network 31. The gateway comprises, for example, a first decrypter 242 α using a gateway private key priv_k_{G} stored in the gateway 2α. The receiver 25α provides the frame received 7′.t*′ to the first decrypter 242α which formulates the decrypted frame 8′.ti, 9′.ts. If the decrypter 242α succeeds in its operation on the received frame, that is to say if it uses the gateway private key paired with the gateway public key used by the communication device 1 to encrypt the frame. The filter 24α provides the decrypted frame 9′.tsα so that it is transmitted, in particular by means of the second sender 22α of the gateway 2α, via the second communication network 32 to the destination network server 4α if decryption is successful. In the case of FIG. 6, the communication device 1 being attached to a first operator infrastructure α comprising the network server 49′.tsα, the frames being destined for it 9′. tsα are transmitted by the gateway 2α: 10′.t_snd2. Optionally, if the frames are destined for a network server 4β of a second operator infrastructure β, the filter 24 blocks them as shown by the cross on the transmission destined for the network server 4β.

Thus, the network server 4α receives only the frames belonging to the same operator infrastructure α as it: 10′.t_snd2 in particular by means of the receiver 43α. The analyzer 45α therefore performs its operations solely on the frames originating from a communication device attached to the same operator infrastructure.

Optionally, the network server 4α furthermore comprises a second decrypter 44 α authenticating the communication device 1 that dispatched the frame 11′.tsα by means of the network public key pub_k_{O}. The second decrypter 44 αprovides the authenticated frame 12′. tu to the analyzer 45 α.

The invention also envisages a medium. The information medium can be any entity or device capable of storing the program. For example, the medium can comprise a storage means, such as a ROM, for example a CD ROM or a microelectronic circuit ROM or else a magnetic recording means, for example a diskette or a hard disk.

Moreover, the information medium can be a transmissible medium such as an electrical or optical signal which can be conveyed via an electrical or optical cable, by radio or by other means. The program according to the invention can be in particular downloaded over a network in particular of Internet type.

Alternatively, the information medium can be an integrated circuit in which the program is incorporated, the circuit being adapted to execute or to be used in the execution of the method in question.

In another implementation, the invention is implemented by means of software components and/or hardware components. In this regard the term module can correspond equally well to a software component or to a hardware component. A software component corresponds to one or more computer programs, one or more subprograms of a program, or more generally to any element of a program or of an item of software able to implement a function or a function set according to the description hereinabove. A hardware component corresponds to any element of a hardware set able to implement a function or a set of functions.

Although the present disclosure has been described with reference to one or more examples, workers skilled in the art will recognize that changes may be made in form and detail without departing from the scope of the disclosure and/or the appended claims.

1. A method of verification of membership in an operator infrastructure of a destination server of frames received by a gateway of the operator infrastructure, the method of verification comprising the following acts performed by the gateway:
receiving frames transmitted over a first network by a communication device; and
performing a first decryption of the frames received by using a gateway private key stored in the gateway, termed a gateway decryption, a success of the gateway decryption of a frame indicating that the decrypted frame belongs to the operator infrastructure.

2. The method of verification of membership as claimed in claim 1, wherein the method of verification comprises the gateway comparing a digest contained in the decrypted frame with a digest of a useful part of decrypted frame generated by using an integrity key contained in the decrypted frame, a result of equality of the comparison indicating the success of the gateway decryption of the frame.

3. A method of filtering frames received by a gateway of a network infrastructure, the method of filtering comprising the following acts performed by the gateway:
receiving at least one frame from a communication device via a first communication network;
decrypting the frame using a gateway private key stored in the gateway to produce at least one decrypted frame; and
in response to the act of decrypting being successful, transmitting the at least one decrypted frame to a network server of the network infrastructure via a second communication network.

4. The method of filtering as claimed in claim 3, wherein the method of filtering comprises blocking a decrypted frame of the at least one decrypted frame in response to the gateway decryption of the decrypted frame being a failure.

5. A method of generating asymmetric gateway keys, comprising the following acts performed by a key generating device:
upon the attachment of a communication device to an operator infrastructure, generating a gateway public key and a gateway private key pair;
transmitting the gateway public key of the pair to the communication device; and
transmitting the gateway private key of the pair to at least one gateway of the operator infrastructure.

6. A gateway of a network operator infrastructure, the gateway comprising:
a processor; and
a non-transitory computer-readable medium comprising instructions stored thereon which when executed by the processor configure the gateway to perform acts comprising:
receiving at least one frame from a communication device via a first communication network;
decrypting the frame using a gateway private key stored in the gateway to produce at least one decrypted frame;
in response to the act of decrypting being successful, transmitting the at least one decrypted frame to a network server of the network infrastructure via a second communication network.
